(19) United States
(12) Patent Application Publication
(10) Pub. No.: US 2025/0033383 A1
(43) Pub. Date: Jan. 30, 2025

(54) IMAGE RECORDING APPARATUS

(71) Applicant: BROTHER KOGYO KABUSHIKI KAISHA, Nagoya (JP)

(72) Inventor: WATARU SUGIYAMA, Nishio (JP)

(73) Assignee: BROTHER KOGYO KABUSHIKI KAISHA, Nagoya (JP)

(21) Appl. No.: 18/785,267

(22) Filed: Jul. 26, 2024

(30) Foreign Application Priority Data
Jul. 28, 2023 (JP) 2023-123040

(51) Int. Cl. B41J 11/70; B41J 11/00; B41J 13/10; B41J 15/04; B41J 29/13; B41J 29/46

(52) U.S. Cl. CPC B41J 11/70; B41J 11/0095; B41J 13/103; B41J 15/042; B41J 15/046; B41J 15/048; B41J 29/13; B41J 29/46

(57) ABSTRACT

An image recording apparatus configured to record an image on a sheet is provided. The image recoding apparatus includes: an insertion port into which a sheet unwound from a first roll disposed outside the image recording apparatus is inserted; a conveyer configured to convey the sheet inserted from the insertion port, along a first conveyance route in a conveyance direction; and a cutter configured to cut the sheet conveyed by the conveyer, the cutter being located downstream in the conveyance direction of the insertion port in the first conveyance route. The conveyer includes a holding part configured to hold the sheet cut by the cutter, the holding part being located between the insertion port and the cutter in the first conveyance route.

### REFERENCE TO RELATED APPLICATIONS

This application claims priority from Japanese Patent Application No. 2023-123040 filed on Jul. 28, 2023. The entire content of the priority application is incorporated herein by reference.

### BACKGROUND ART

A certain known image forming apparatus includes a main apparatus body (image recording apparatus) and a roll accommodating part disposed outside the main apparatus body. A roll (first roll), around which a long sheet (sheet-shaped medium) is wound, is accommodated in the roll accommodating part. Further, the roll accommodating part has a sheet feed roller configured to convey the sheet unwound from the roll, and a cutter configured to cut the sheet conveyed by the sheet feed roller.

### SUMMARY

In the image forming apparatus as described above, in a case where the sheet of the roll is cut by the cutter, the forward end of the sheet, which is formed by the cutting, is disposed in the roll accommodating part. Accordingly, the following operation is required in order to record a new image on the sheet after cutting the sheet. By this operation, the forward end of the sheet is inserted into an insertion port disposed in the main apparatus body so that the sheet can be conveyed by a conveying mechanism disposed in the main apparatus body.

An object of the present disclosure is to provide an image recording apparatus that contributes to reducing the deterioration of convenience in a case where a new image is recorded after cutting the sheet-shaped medium unwound from the roll disposed outside the apparatus.

According to an aspect of the present disclosure, there is provided an image recording apparatus configured to record an image on a sheet. The image recording apparatus includes: an insertion port; a conveyor; and a cutter. A sheet unwound from a first roll disposed outside the image recording apparatus is inserted into the insertion port. The conveyer is configured to convey the sheet inserted from the insertion port, along a first conveyance route in a conveyance direction. The cutter is configured to cut the sheet conveyed by the conveyer. The cutter is disposed downstream in the conveyance direction of the insertion port in the first conveyance route. The conveyer includes a holding part configured to hold the sheet cut by the cutter. The holding part is located between the insertion port and the cutter in the first conveyance route.

According to the image recording apparatus of the present disclosure, the sheet, which is cut by the cutter, is held by the holding part between the insertion port and the cutter. Accordingly, the operation, in which the forward end of the sheet formed by the cutting is inserted into the insertion port after cutting the sheet so that the sheet can be conveyed by the conveying mechanism, is not required. As a result, the deterioration of convenience can be reduced in a case where a new image is recorded after the cutting of the sheet unwound from the first roll disposed outside the apparatus.

### BRIEF DESCRIPTION OF DRAWINGS

FIG. 1 is a schematic side view depicting the internal structure of a printer system including a printer.

FIG. 2 is a schematic side view depicting the internal structure of the printer depicted in FIG. 1.

FIG. 3 is a block diagram depicting the electric configuration of the printer depicted in FIG. 2.

FIG. 4A is a view depicting a state in which any rolled sheet is not inserted from an insertion port and a state in which any rolled sheet of a second roll is not located in a passage, and FIG. 4B is a view depicting a state in which the rolled sheet is inserted from the insertion port and a state in which the rolled sheet of the second roll is located in the passage.

FIG. 5A is a view depicting a state in which the rolled sheet is not located at a position at which the rolled sheet can be fed by a feed roller, and FIG. 5B is a view depicting a state in which the rolled sheet is located at the position at which the rolled sheet can be fed by the feed roller.

FIG. 6 is a flow chart depicting an exemplary procedure of a process in which notification control is executed for the printer depicted in FIG. 2.

FIG. 7 is a schematic side view depicting an internal structure of a printer system including a printer.

### DESCRIPTION

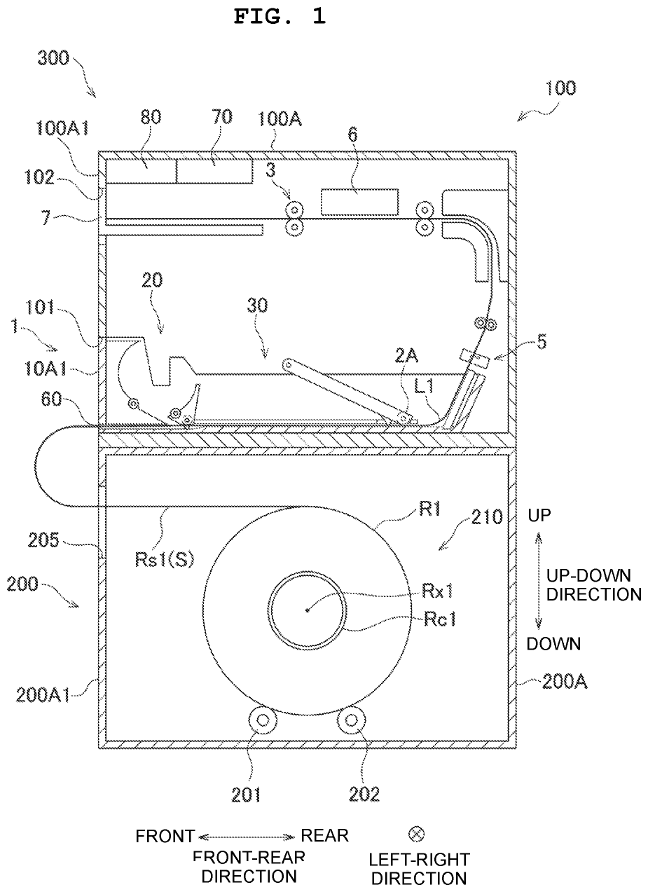

A printer system 300, which includes a printer (“image recording apparatus” of the present disclosure) according to an embodiment of the present disclosure, will be described below with reference to FIGS. 1 to 5. Note that the up-down direction, the front-rear direction, and the left-right direction depicted in FIG. 1 are designated as the up-down direction, the front-rear direction, and the left-right direction of the printer 100 respectively. The left-right direction is the direction in the printer 100 in a case where the printer 100 is viewed from a front position. The front side in relation to the sheet surface of FIG. 1 is the right, and the rear side in relation to the sheet surface of FIG. 1 is the left.

### Overall Configuration of Printer System 300

As depicted in FIG. 1, the printer system 300 includes the printer 100 and an accommodating unit 200. The printer 100 is configured such that a rolled sheet Rs1, which is unwound from a first roll R1 described later on, is conveyed along a first conveyance route L1, and an image can be recorded on the rolled sheet Rs1. The printer 100 is disposed on the accommodating, and the first roll R1 is accommodated in the accommodating unit 200.

### Overall Configuration of Accommodating Unit 200

The accommodating unit 200 includes a casing 200A having a substantially rectangular parallelepiped shape. The casing 200A has an accommodating part 210 which is capable of accommodating the first roll R1. The first roll R1 has the rolled sheet Rs1 (“sheet-shaped medium” of the present disclosure) wound around the outer circumferential surface of a cylindrical core member Rc1. The rolled sheet Rs1 is a sheet which is longer that a cut sheet Ks described later on. The first roll R1 is accommodated in the accommodating part 210 so that the axial direction of the central shaft Rx1 thereof is coincident with the left-right direction.

The accommodating part 210 has two rollers 201, 202. Each of the two rollers 201, 202 is disposed rotatably about a rotation shaft extending in the left-right direction. The rollers 201, 202 are disposed while being separated from each other in the front-rear direction. The two rollers 201, 202 support the first roll R1 from below in a state in which the two rollers 201, 202 are brought in contact with the outer circumferential surface of a lower part of the first roll R1.

Further, an outlet 205, which communicates the inside and the outside of the casing 200A, is defined through a front surface 200A1 of the casing 200A. The rolled sheet Rs1, which is unwound from the first roll R1 disposed in the casing 200A, passes through the outlet 205 to exit to the outside of the casing 200A. Note that as for the accommodating unit 200, the rolled sheet Rs1, which is unwound from the first roll R1, can be inserted into an insertion port 60 (to be described later on) of the printer 100. The accommodating unit 200 may be disposed at any position other than the lower position of the printer 100, or the accommodating unit 200 may be disposed at any position at which the accommodating unit 200 does not abut against the printer 100.

### Overall Configuration of Printer 100

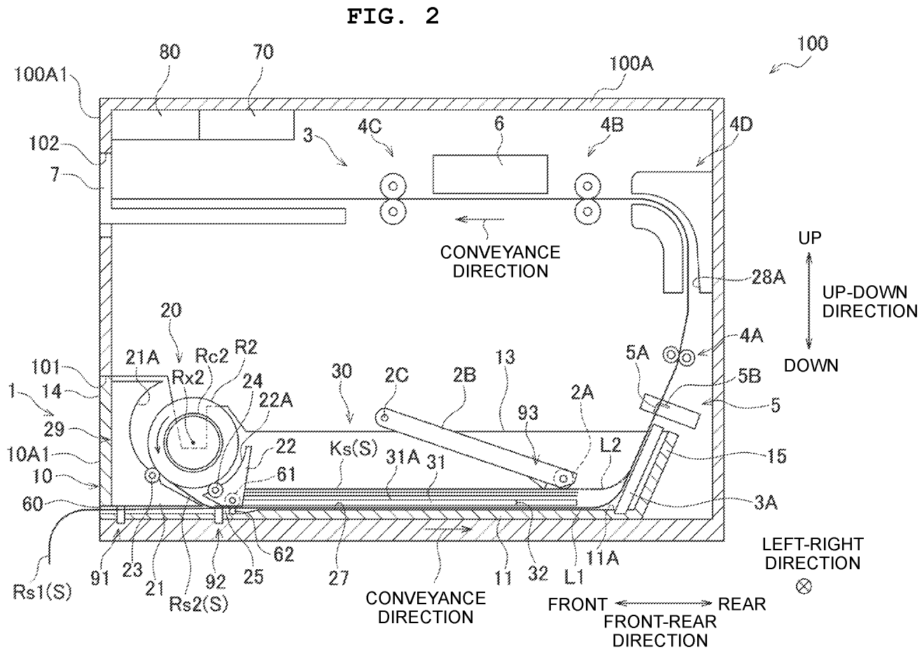

As depicted in FIG. 2, the printer 100 mainly includes a casing 100A, a feed tray 1, a conveyer 3, a cutter 5, a head 6, a sheet discharge tray 7, a controller 70, a notifying part 80, first detecting part 91, a second detecting part 92, and a third detecting part 93. The feed tray 1 is disposed below the head 6 in the casing 100A.

As depicted in FIG. 2, the feed tray 1 can be inserted into and pulled from the casing 100A in the front-rear direction via an opening 101 which is defined in affront surface 100A1 of the casing 100A. That is, the feed tray 1 is movable in the front-rear direction between an inner position (position depicted in FIG. 2) inside the casing 100A and an outer position outside the casing 100A. The inner position is a position of the feed tray 1 in a case where the feed tray 1 is located at a rearmost position in the casing 100A. The outer position is a position of the feed tray 1 in a case where the feed tray 1 is located in front of the inner position. Further, the feed tray 1 of this embodiment is configured so that the entirety of the feed tray 1 can be pulled from the casing 100A. The feed tray 1 may be configured such that the feed tray 1 can be pulled from the casing 100A only to such a state that a part (for example, a rear end part) of the feed tray 1 remains in the casing 100A.

The feed tray 1 has a main tray body 10. The main tray body 10 has a bottom wall 11 and four side walls which includes side walls 13 to 15 and which are provided at circumferential end parts of the bottom wall 11. The main tray body 10 has a box-shaped form which is open upward. Note that the three side walls 13 to 15 of the four side walls are depicted in FIG. 2. The remaining side wall is opposed to the side wall 13 in the left-right direction and is disposed between the side walls 14, 15.

The bottom wall 11 extends in the front-rear direction and the left-right direction. The upper surface of the bottom wall 11 is a bottom surface 11A of the feed tray 1. As depicted in FIG. 2, the bottom surface 11A supports the rolled sheet Rs1 unwound from the first roll R1 and a rolled sheet Rs2 unwound from a second roll R2 from below (the second roll R1 will be described later on).

The pair of side walls 13, included in the four side walls including the wide walls 13 to 15 and disposed on the left and right sides, extend upward from both left and right end parts of the bottom wall 11. Further, the pair of side walls 13 extend in the front-rear direction from a front end part to a rear end part of the bottom wall 11. The side wall 14 extends upward from the front end part of the bottom wall 11. The side wall 14 extends in the left-right direction from the right end part to the left end part of the bottom wall 11.

Two side walls 15 are provided at the rear end part of the bottom wall 11. The two side walls 15 are positioned respectively at the both end parts in the left-right direction at the rear end part of the bottom wall 11. The two side walls 15 are disposed while being separated from each other in the left-right direction. In a case where the feed tray 1 is attached to the casing 100A, a separation wall 3A (to be escribed later on; see FIG. 2) is positioned between the two side walls 15 which are aligned in the left-right direction.

The feed tray 1 has a first accommodating part (“accommodating part” of the present disclosure) 20 which is capable of accommodating the second roll R2, and a second accommodating part (“accommodating part” of the present disclosure) 30 which is capable of accommodating a plurality of cut sheet Ks in a stacked state. The second roll R2 has the rolled sheet Rs2 (“sheet-shaped medium” of the present disclosure), which is a sheet which is longer than the cut sheet Ks, is wound in a roll form around the outer circumferential surface of a cylindrical core member Rc2. Note that the maximum length of the rolled sheet Rs2 of the second roll R2 is shorter than the maximum length of the rolled sheet Rs1 of the first roll R1. The second roll R2 is accommodated in the first accommodating part 20 so that the axial direction of the central axis Rx2 thereof is coincident with the left-right direction. The cut sheet Ks is, for example, a sheet having the A4 size or the letter size. The cut sheet Ks is accommodated in the second accommodating part 30 so that the longitudinal direction thereof is coincident with the left-right direction.

Note that for the purpose of description, FIG. 2 depicts a state in which both of the second roll R2 and the cut sheet Ks are accommodated in the feed tray 1. However, in a case where an image is to be recorded on the rolled sheet Rs2 by the printer 100, then the second roll R2 is accommodated in the feed tray 1, and the cut sheet Ks is removed from the feed tray 1. On the other hand, in a case where an image is to be recorded on the cut sheet Ks, the cut sheet Ks is accommodated in the feed tray 1, and the second roll R2 is removed from the feed tray 1, or the rolled sheet Rs2 is removed from passages 25, 27 (to be described later on). Further, in a case where an image is to be recorded on the rolled sheet Rs2 or the cut sheet Ks by the printer 100, the rolled sheet Rs1, which is unwound from the first roll R1, is removed from the passages 25, 25. Further, in a case where an image is to be recorded on the rolled sheet Rs1 unwound from the first roll R1 by the printer 100, then the cut sheet Ks is removed from the feed tray 1, and the second roll R2 is removed. In another case, in a case where an image is to be recorded on the rolled sheet Rs1 unwound from the first roll R1 by the printer 100, the rolled sheet Rs2 is removed from the passages 25, 27.

As depicted in FIG. 2, the first accommodating part 20 and the second accommodating part 30 are aligned in the front-rear direction. The first accommodating part 20 is positioned in front of the second accommodating part 30. Further, the first accommodating part 20 has a support part 29 which supports the second roll R2 from below.

The support part 29 has two holders 21, 22, and two rollers 23, 24. The two holders 21, 22 are disposed while being separated from each other in the front-rear direction. The holder 21 is positioned in front of the holder 22. Each of the two holders 21, 22 extends in the left-right direction.

The roller 23 is mounted to the holder 21 rotatably about the rotation shaft extending in the left-right direction. The roller 24 is mounted to the holder 22 rotatably about the rotation shaft extending in the left-right direction. The rollers are disposed while being separated from each other in the front-rear direction. The roller 23 is positioned above the roller 24. The two rollers 23, 24 support the roll R2 from below in a state in which the two rollers 23, 24 are brought in contact with the outer circumferential surface of a lower part of the second roll R2.

As depicted in FIG. 2, the holder 21 has a curved surface 21A which covers the outer circumferential surface on the front side of the second roll R2. The holder 22 has a curved surface 22A which covers the outer circumferential surface on the rear side of the second roll R2 (mainly the lower part of the second roll R2).

As depicted in FIG. 2, the passage 25 is formed between the bottom surface 11A and the lower surfaces of the two holders 21, 22. The passage 25 extends in the front-rear direction and the left-right direction.

Further, the insertion port 60 is formed in a front surface 10A1 of the main tray body 10. The insertion port 60 penetrates through the side wall 14 in the front-rear direction, and the insertion port 60 is communicated with the passage 25. The width in the left-right direction of the insertion port 60 is approximately the same as that of the passage 25. Each of the insertion port 60 and the passage 25 has such a size that allows the rolled sheet Rs1, Rs2 to pass therethrough.

The rolled sheet Rs2, which is unwound from the second roll R2 accommodated in the first accommodating part 20, is allowed to pass through the passage 25 from the space between the two holders 21, 22, and the rolled sheet Rs2 is drawn to a base pad (not depicted) along the bottom surface 11A. Accordingly, the rolled sheet Rs2 is in a state in which the rolled sheet Rs2 can be fed. Further, as depicted in FIG. 1, the rolled sheet Rs1, which is unwound from the first roll R1 accommodated in the accommodating unit 200, exits to the outside from the outlet 205 of the accommodating unit 200, and the rolled sheet Rs1 is inserted into the insertion port 60. Then, the rolled sheet Rs1 is allowed to pass through the passage 25, and the rolled sheet Rs1 is drawn to the base pad (not depicted) along the bottom surface 11A. Accordingly, the rolled sheet Rs1 is in a state in which the rolled sheet Rs1 can be fed.

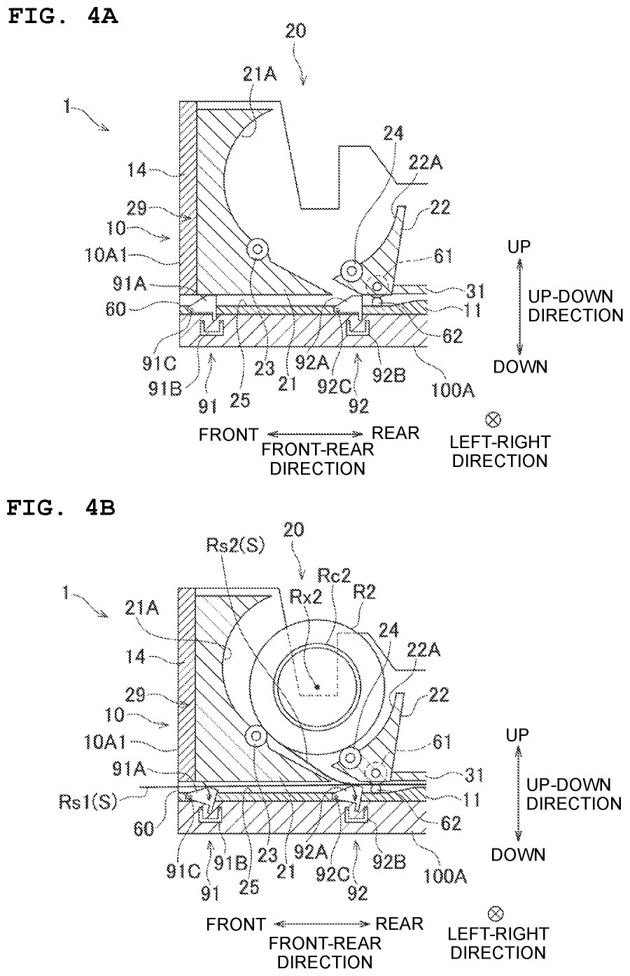

As depicted in FIGS. 2 and 4, the feed tray 1 has a pair of rollers (each of which is a “part of the conveyer: holding part” of the present disclosure) 61, 62. The roller 61 is disposed at a lower part of the holder 22. The roller 61 is mounted to the holder 22 rotatably about a rotation shaft extending in the left-right direction. A lower part of the roller 61 is disposed below the lower surface of the holder 22 and positioned in the passage 25. The roller 61 is a driven roller which is rotated while following the conveyance of the rolled sheet Rs1, Rs2.

The roller 62 is rotatable around a rotation shaft extending in the left-right direction. The roller 62 is also a driven roller which is rotated while following the conveyance of the rolled sheet Rs1, Rs2 in the same manner as the roller 61. The roller 62 is biased by an unillustrated biasing mechanism toward the roller 61. In other words, the pair of rollers 61, 62 are configured so that the rolled sheet Rs1, Rs2 can be nipped and held therebetween. Further, the roller 61 is a roller quipped with a known one-way clutch, and the roller 61 is rotatable counterclockwise as viewed in FIG. 2. Accordingly, the pair of rollers 61, 62 also function as a holding part configure to hold the rolled sheet Rs1 connected to the first roll R1 or the rolled sheet Rs2 connected to the second roll R2 cut by the cutter 5. Note that the roller 61 equipped with the one-way clutch may have a known torque limiter.

Further, the biasing mechanism is configured so that the roller 62 is released from the biasing force exerted on the roller 62 in a case where the feed tray 1 is located at the outer position. Accordingly, the rolled sheet Rs1, Rs2, which is held by the pair of rollers 61, 62, can be pulled from the pair of rollers 61, 62 by moving the feed tray 1 to the outer position.

As depicted in FIG. 2, the second accommodating part 30 has a support plate 31 which supports the cut sheet Ks from below. The support plate 31 is a plate-shaped member extending in the front-rear direction and the left-right direction. The upper surface of the support plate 31 is a support surface 31A. The support plate 31 has a part, in a front end part thereof, which is inserted into a lower part of the holder 22, and which is disposed on the bottom surface 11A. Further, the support plate 31 is configured so that a rear end part of the support plate 31 is swingable in the vertical direction, with the part, of the support plate, which is inserted into the holder 22 as the fulcrum of the swinging motion. Further, the support plate 31 extends rearward from the fulcrum up to the vicinity of a rear end part of the bottom surface 11A.

Further, as depicted in FIG. 2, the support plate 31 and the bottom wall 11 define the passage 27. The support plate 31 is disposed to face the bottom surface 11A so that the rolled sheet Rs1, Rs2 can pass through the space between the support plate 31 and the bottom surface 11A. The first conveyance route L1 is a route along which the rolled sheet Rs1 is conveyed from the insertion port 60 via the passages 25, 27 to the cutter 5. Note that the rolled sheet Rs2 is conveyed to the cutter 5 along the first conveyance route L1 from an intermediate position of the passage 25. Further, the support plate 31 also has the function to prevent the curling of the rolled sheet Rs1, Rs2 passing through the space between the support plate 31 and the bottom surface 11A.

A cutout 32 is formed at a rear end part of the support plate 31. The cutout 32 is disposed at the central part in the left-right direction of the support plate 31. The cutout 32 is positioned on the movement locus of the feed roller 2A (to be described later on) which is movable from a contact position to a separated position. Note that the base pad is positioned in the cutout 32 of the support plate 31 as viewed in a top view.

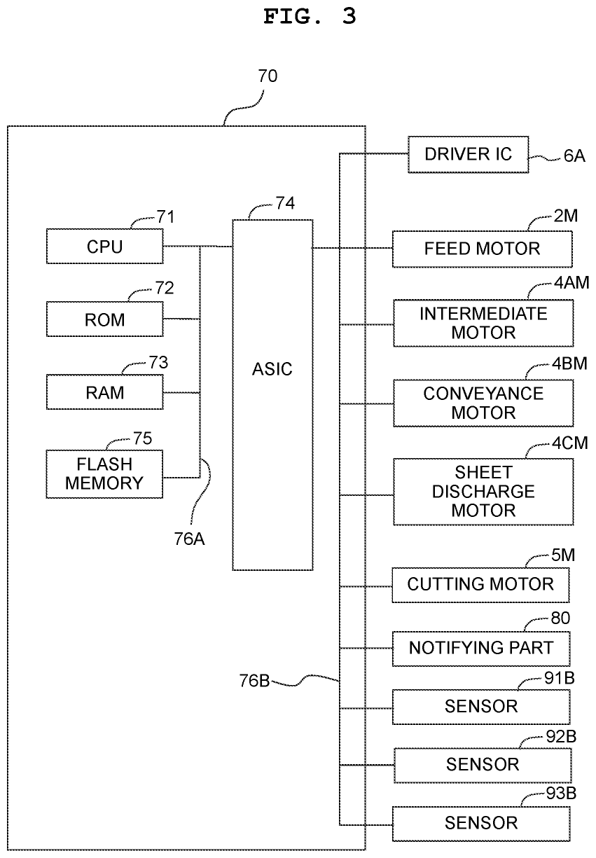

The conveyer (“conveyer” of the present disclosure) 3 conveys, in the conveyance direction, the rolled sheet Rs1 unwound from the first roll R1, the rolled sheet Rs2 unwound from the second roll R2, and the cut sheet(s) Ks. As depicted in FIGS. 2 and 3, the conveyer 3 has the pair of rollers 61, 62 described above, the feed roller 2A, an arm 2B, the separation wall 3A, an intermediate roller pair 4A, a conveyance roller pair 4B, a sheet discharge roller pair 4C, a guide 4D, a feed motor 2M, an intermediate motor 4AM, a conveyance motor 4BM, and a sheet discharge motor 4CM.

The feed roller (“holding part” of the present disclosure) 2A feeds the rolled sheet Rs1, Rs2 along the first conveyance route L1 from the feed tray 1 toward the cutter 5 and the intermediate roller pair 4A. The feed roller 2A is a roller equipped with a known one-way clutch, and the feed roller 2A is rotatable counterclockwise as viewed in FIG. 2. Further, the feed roller 2A feeds the cut sheet Ks accommodated in the second accommodating part 30 from the feed tray 1 along a second conveyance route L2. The second conveyance route L2 is a route indicated by a two-dot chain line in FIG. 2 along which the cut sheet Ks is conveyed from the second accommodating part 30 to the cutter 5. In the following description, in a case where the cut sheet Ks and the rolled sheet Rs1, Rs2 are not distinguished from each other, the cut sheet Ks and the rolled sheet Rs1, Rs2 are referred to as “sheet S”. Further, in a case where the rolled sheet Rs1 and the rolled sheet Rs2 are not distinguished from each other, the cut sheet KsF and the rolled sheet Rs1, Rs2 are referred to as “rolled sheet Rs”.

The feed roller 2A is rotatably supported at the forward end of the arm 2B. The feed roller 2A is rotated around the shaft extending in the left-right direction in accordance with the driving of the feed motor 2M.

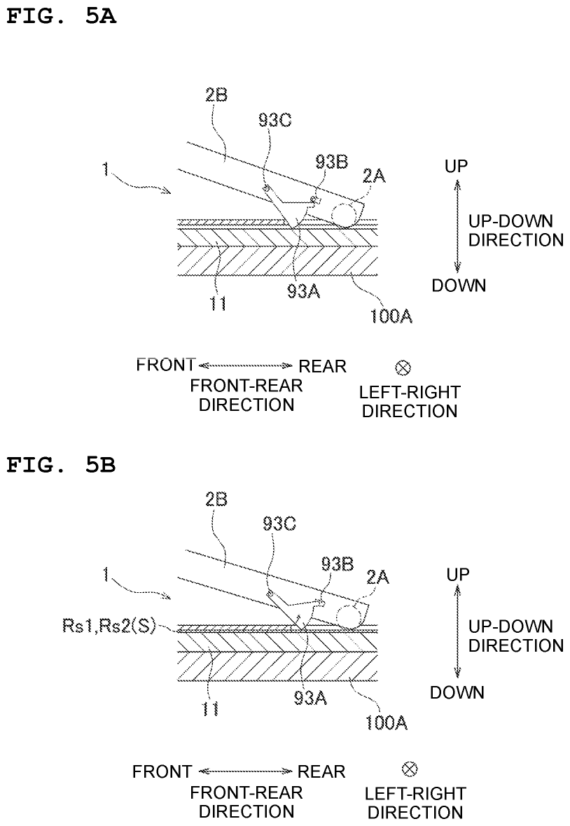

The arm 2B is supported rotatably by a support shaft 2C. The support shaft 2C is supported by the casing 100A. The arm 2B is biased by an unillustrated biasing member so that the feed roller 2A approaches the bottom surface 11A of the feed tray 1. The arm 2B is rotated around the support shaft 2C. Accordingly, the feed roller 2A is movable between the contact position (see FIG. 5A) at which the feed roller 2A is brought in contact with the base pad (not depicted) disposed at the bottom surface 11A of the feed tray 1 and the separated position at which the feed roller 2A is separated from the base pad. Owing to this configuration, the feed roller 2A also functions as a holding part which is configured to nip and hold, in cooperation with the base pad, the rolled sheet Rs1 connected to the first roll R1 cut by the cutter 5. In another case, the feed roller 2A also functions as a holding part which is configured to nip and hold, in cooperation with the base pad, the rolled sheet Rs2 connected to the second roll Rs cut by the cutter 5. The feed roller 2A is the roller equipped with the one-way clutch, and hence the rolled sheet Rs can be effectively held. Note that the one-way clutch of the feed roller 2A may have a known torque limiter.

The feed tray 1 is moved from the inner position inside the casing 100A to the outer position outside the casing 100A by a non-depicted retracting mechanism. Accompanying this, the arm 2B can be retracted to a retracted position at which the main tray body 10 of the feed tray 1 does not interfere with the feed roller 2A. The separated position is a position to which the feed roller 2A is moved in a case where the arm 2B is moved to the retracted position. Accordingly, the rolled sheet Rs, which is held by the feed roller 2A, is released from the holding by the feed roller 2A in accordance with the movement of the feed tray 1 to the outer position.

Further, the feed roller 2A selectively takes a first feed position and a second feed position between the contact position and the separated position. The first feed position is a position (see FIG. 5B) at which the feed roller 2A is brought in contact with the rolled sheet Rs supported by the bottom surface 11A of the feed tray 1. The second feed position is a position (see FIG. 2) at which the feed roller 2A is brought in contact with the cut sheet Ks accommodated in the second accommodating part 30.

In a case where the feed motor 2M is driven in accordance with the control of the controller 70, the feed roller 2A is rotated, and a conveyance force, which is in a direction from the front to the rear, is applied to the sheet S which is brought in contact with the feed roller 2A. Accordingly, the sheet S is fed from the feed tray 1.

The separation wall 3A avoids any duplicated feeding in a case where the cut sheets Ks are fed from the feed tray 1. As depicted in FIG. 2, the separation wall 3A extends obliquely upward from the bottom surface 11A of the feed tray 1. The separation wall 3A is disposed on the casing 100A. The separation wall 3A is positioned at the rear end part of the feed tray 1 in the front-rear direction.

The intermediate roller pair 4A is constructed of a driving roller which is rotated by the transmission of the driving force of the intermediate motor 4AM and a driven roller which is rotated while following the driving roller. In a case where the intermediate motor 4AM is driven in accordance with the control of the controller 70, the intermediate roller pair 4A is rotated while nipping the sheet S, and the sheet S is conveyed. The intermediate roller pair 4A is positioned above the separation wall 3A. The intermediate roller pair 4A nips and conveys the sheet S fed from the feed tray 1 by the feed roller 2A upward. The guide 4D is positioned above the intermediate roller pair 4A. The guide 4D has a passage 28A configured to guide the sheet S conveyed upward by the intermediate roller pair 4A frontward.

The conveyance roller pair 4B includes a driving roller which is rotated by the transmission of the driving force of the conveyance motor 4BM and a driven roller which is rotated while following the driving roller. The sheet discharge roller pair 4C is constructed of a driving roller which is rotated by the transmission of the driving force of the sheet discharge motor 4CM and a driven roller which is rotated while following the driving roller. In a case where the conveyance motor 4BM and the sheet discharge motor 4CM are driven in accordance with the control of the controller 70, the conveyance roller pair 4B and the sheet discharge roller pair 4C are rotated while nipping the sheet S, and thus the sheet S is conveyed. The conveyance roller pair 4B is positioned behind the head 6, and the sheet discharge roller pair 4C is positioned in front of the head 6. The conveyance roller pair 4B conveys the sheet S frontward while nipping the sheet S guided frontward by the guide 4D. The sheet discharge roller pair 4C conveys the sheet S frontward while nipping the sheet S conveyed frontward by the conveyance roller pair 4B.

As depicted in FIG. 2, the cutter 5 is positioned between the separation wall 3A and the intermediate roller pair 4A. The cutter 5 includes a fixed blade 5A which is slender and long in the left-right direction, a disc-shaped rotary blade 5B which is movable in the left-right direction while being brought in contact with the fixed blade 5A, and a cutting motor 5M. The rotary blade 5B is rotated in accordance with the driving of the cutting motor 5M, and the rotary blade 5B reciprocates in the left-right direction. The rolled sheet Rs is cut in the left-right direction by the fixed blade 5A and the rotary blade 5B by driving the cutting motor 5M in accordance with the control of the controller 70. Accordingly, a rear end is formed in the rolled sheet Rs fed to the sheet discharge tray 7, and a forward end is formed in the rolled sheet Rs1 connected to the first roll R1 or the rolled sheet Rs2 connected to the second roll R2.

The head 6 includes a plurality of nozzles (not depicted) which are formed in the lower surface of the head 6, and a driver IC 6A (see FIG. 3). The head 6 records an image on the sheet S conveyed by the conveyer 3. In a case where the driver IC 6A is driven in accordance with the control of the controller 70, an ink is ejected from the nozzles. Then, the image is formed on the sheet S in a case where the sheet S, which is conveyed by the conveyer 3, passes through an image recording position facing the lower surface of the head 6. Note that the head 6 may be based on any one of the line system in which the ink is ejected from the nozzles in a state in which the position of the head 6 is fixed and the serial system in which the ink is ejected from the nozzles while the head 6 is moved in the left-right direction.

The sheet discharge tray 7 is disposed in front of the head 6 in the casing 100A above the feed tray 1. The sheet discharge tray 7 is insertable into and pullable from the casing 100A in the front-rear direction, via an opening 102 formed in the front surface 100A1 of the casing 100A. The sheet discharge tray 7 receives the sheet S having the image formed thereon by the head 6 conveyed frontward by the sheet discharge roller 43.

The first detecting part 91 detects whether the rolled sheet Rs1 is inserted into the passage 25 from the insertion port 60. As depicted in FIG. 4A, the first detecting part 91 is disposed in front of the second detecting part 92.

As depicted in FIG. 4A, the first detecting part 91 includes an actuator 91A and a sensor 91B. The actuator 91A is supported rotatably around a rotation shaft 91C. The axial direction of the rotation shaft 91C is parallel to the left-right direction. The sensor 91B is a sensor which detects the actuator 91A. The sensor 91B is, for example, a photosensor which has a light-emitting element and a light-receiving element (not depicted). The actuator 91A is biased in the counterclockwise direction, as viewed in FIG. 4A by a biasing member (not depicted). In a case where the external force is not exerted, the actuator 91A is positioned in the first conveyance route L1 as depicted in FIG. 4A. In this situation, the actuator 91A does not intercept the optical path of the sensor 91B.

As depicted in FIG. 4A, in a case where the rolled sheet Rs1 is not inserted into the passage 25 from the insertion port 60, the external force is not exerted on the actuator 91A, and the actuator 91A is located at a position at which the actuator 91A does not intercept the optical path of the sensor 91B. In other words, the sensor 91B outputs, to the controller 70, a first signal which indicates that the rolled sheet Rs1 is not inserted. On the other hand, in a case where the rolled sheet Rs1 is inserted into the passage 25 from the insertion port 60, the rolled sheet Rs1 is brought in contact with the actuator 91A as depicted in FIG. 4B, and the actuator 91A is pushed downward by the rolled sheet Rs1. Accordingly, the actuator 91A is rotated clockwise as viewed in FIG. 4B around the rotation shaft 91C, and the actuator 91A intercepts the optical path of the sensor 91B. In other words, the sensor 91B outputs, to the controller 70, a second signal which indicates that the rolled sheet Rs1 is inserted. In this manner, the first detecting part 91 can detect that the rolled sheet Rs1 is inserted into the passage 25 from the insertion port 60.

The second detecting part 92 detects whether the rolled sheet Rs is inserted into the passage 25. As depicted in FIG. 4A, the second detecting part 92 includes an actuator 92A and a sensor 92B. The second detecting part 92 is configured in the same manner as the first detecting part 91. Therefore, detailed description will be omitted.

As depicted in FIG. 4A, in a case where the rolled sheet Rs is not located in the passage 25, the external force is not exerted on the actuator 92A, and the actuator 92A is located at a position at which the actuator 92A does not intercept the optical path of the sensor 92B. In other words, the sensor 92B outputs, to the controller 70, a third signal which indicates that the rolled sheet Rs is not located in the passage 25. On the other hand, in a case where the rolled sheet Rs is located in the passage 25, the rolled sheet Rs is brought in contact with the actuator 92A as depicted in FIG. 4B, and the actuator 92A is pushed downward by the rolled sheet Rs. Accordingly, the actuator 92A is rotated clockwise as viewed in FIG. 4B around the rotation shaft 92C, and the actuator 92A intercepts the optical path of the sensor 92B. In other words, the sensor 92B output, to the controller 70, a fourth signal which indicates that the rolled sheet Rs is located in the passage 25. In this manner, the second detecting part 92 can detect that the rolled sheet Rs is located in the passage 25.

The third detecting part 93 detects whether the sheet S is located at a position at which the sheet S can be fed by the feed roller 2A. The third detecting part 93 is mounted to the arm 2B.

As depicted in FIG. 5A, the third detecting part 93 includes an actuator 93A and a sensor 93B. The actuator 93A is supported by the arm 2B so that the actuator 93A is rotatable around a rotation shaft 93C. The axial direction of the rotation shaft 93C is parallel to the left-right direction. The sensor 93B is a sensor which detects the actuator 93A. The sensor 93B is mounted to the arm 2B. The sensor 93B is, for example, a photosensor which has a light-emitting element and a light-receiving element (not depicted).

In a case where the sheet S is not located at the position at which the sheet S can be fed by the feed roller 2A (position at which the sheet S makes contact with the feed roller 2A), the external force is not exerted on the actuator 93A. Therefore, the actuator 93A is located at a position at which the actuator 93A does not intercept the optical path of the sensor 93B as depicted in FIG. 5A. In other words, the sensor 93B output, to the controller 70, a fifth signal which indicates that the sheet S is not located at the position at which the sheet S can be fed. On the other hand, in a case where the sheet S is located at the position at which the sheet S can be fed by the feed roller 2A, the sheet S is brought in contact with the actuator 93A as depicted in FIG. 5B. Note that FIG. 5B depicts such a situation that the rolled sheet Rs is located at the position at which the rolled sheet Rs is brought in contact with the feed roller 2A. In this situation, one end part of the actuator 93A is pushed upward by the sheet S, and thus the actuator 93A is rotated counterclockwise as viewed in FIG. 5B around the rotation shaft 93C. The actuator 93A intercepts the optical path of the sensor 93B. In other words, the sensor 93B outputs, to the controller 70, a sixth signal which indicates that the sheet S is located at the position at which the sheet S can be fed. In this manner, the third detecting part 93 can detect that the sheet S is located at the position at which the sheet S can be fed by the feed roller 2A.

The notifying part 80 is configured to perform the notifying operation of notifying a user of information. In this embodiment, the notifying part 80 is a touch panel display. Further, the notifying part 80 also functions as an accepting part which accepts input from the user in a case that the user touches a screen. In this embodiment, the touch panel display is adopted as the notifying part 80. However, the notifying part 80 may be a speaker or a display provided that the notifying operation of notifying the user of the information can be performed. Further, the notifying part 80 may have an input part into which the information from the user can be inputted, distinctly from the touch panel display.

Next, the control configuration of the printer 100 will be described with reference to FIG. 3. The controller 70 of the printer 100 manages the overall control of the printer 100. The controller 70 includes a CPU 71, a ROM 72 and a RAM 73, ASIC 74, and a flash memory 75 which are connected to one another by a bus 6A. Further, the ASIC 74 of the controller 70 is connected to the driver IC 6A, the feed motor 2M, the intermediate motor 4AM, the conveyance motor 4BM, the sheet discharge motor 4CM, the cutting motor 5M, the notifying part 80, and the three sensors 91B to 93B by a bus 76B. Furthermore, the CPU 71, the ROM 72, the RAM 73, the ASIC 74, and the flash memory 75 cooperate to control the operations of the driver IC 6A, the feed motor 2M, the intermediate motor 4AM, the conveyance motor 4BM, the sheet discharge motor 4CM, the cutting motor 5M, the notifying part 80, etc.

Note that as for the controller 70, only the CPU 71 may perform various processes, only the ASIC 74 may perform various processes, or the CPU 71 and the ASIC 74 may perform various processes in a cooperating manner. Further, as for the controller 70, one CPU 71 may perform the processes singly, or a plurality of CPUs 71 may perform the processes in a shared manner. Further, as for the controller 70, one ASIC 74 may perform the processes singly, or a plurality of ASICs 74 may perform the processes in a shared manner.

### Control During Printing

Next, the control, which is performed in a case where an image is recorded on the rolled sheet Rs by the printer 100, will be described. Note that the rolled sheet Rs1 or the rolled sheet Rs2, on which the image is to be recorded, is assumed to be in a state in which the rolled sheet Rs1 or the rolled sheet Rs2 is previously nipped between the roller 2A and the base pad. In the printer 100, in a case where a recording instruction is received in order to execute the printing, the controller 70 starts the control in order to execute the printing. In a case where the recording instruction is received, the controller 70 firstly starts the conveyance of the rolled sheet Rs toward the head 6 by the conveyer 3.

More specifically, the controller 70 drives the feed motor 2M, and the rolled sheet Rs is conveyed to the cutter 5 and the intermediate roller pair 4A along the first conveyance route L1. In this situation, the rolled sheet Rs is conveyed while being nipped by the pair of rollers 61, 62.

In a case where the rolled sheet Rs is conveyed to the intermediate roller pair 4A, the controller 70 successively controls the intermediate motor 4AM, the conveyance motor 4BM, and the sheet discharge motor 4CM to thereby convey the rolled sheet Rs toward the head 6.

In a case where the rolled sheet Rs arrives at a position at which the rolled sheet Rs faces the head 6, the controller 70 controls the driver IC 6A to thereby cause the ink to be ejected from the nozzles onto the rolled sheet Rs and to record the image. Then, in a case where a part (cutting scheduled position), which is to be the rear end of the rolled sheet Rs, arrives at a cutting position of the cutter 5, the controller 70 controls the conveyer 3 to once stop the conveyance of the rolled sheet Rs. The position of the part which is to be the rear end of the rolled sheet Rs is referred to as “cutting scheduled position”.

Subsequently, the controller 70 drives the cutting motor 5M to cut the rolled sheet Rs by the cutter 5. The rolled sheet Rs, connected to the first roll R1 or the second roll R2 which has been cut, is held between the feed roller 2A and the base pad. Further, the rolled sheet Rs is also held by the pair of rollers 61, 62. In other words, such a state is maintained that the rolled sheet Rs, connected to the first roll R1 or the second roll R2 which has been cut, is located in the feed tray 1. Accordingly, in a case where the controller 70 receives the recording instruction for the next printing, the conveyance of the rolled sheet Rs can be immediately started to execute the printing.

Subsequently, the controller 70 controls the intermediate motor 4AM, the conveyance motor 4BM, and the sheet discharge motor 4CM to discharge the cut rolled sheet Rs to the sheet discharge tray 7. In other words, the controller 70 controls the intermediate motor 4AM, the conveyance motor 4BM, and the sheet discharge motor 4CM to discharge, to the sheet discharge tray 7, the cut rolled sheet Rs disposed downstream in the conveyance direction of the cutter 5. In a case where the image is to be recorded on the upstream part of the rolled sheet Rs disposed upstream in the conveyance direction of the head 6 after cutting the rolled sheet Rs, the controller 70 controls the driver IC 6A to record the image on the rolled sheet Rs. Thus, the control during the printing is ended for the rolled sheet Rs.

Next, the control during the printing, which is to be performed in a case where an image is to be recorded on the cut sheet Ks, will be described. The cut sheet Ks is assumed to be in such a state that the cut sheet Ks is accommodated in the second accommodating part 30, and the cut sheet Ks is brought in contact with the feed roller 2A. In a case where the controller 70 receives the recording instruction, the controller 70 starts the conveyance of the cut sheet Ks toward the head 6 by the conveyer 3.

More specifically, the controller 70 drives the feed motor 2M to thereby cause the cut sheet Ks to be conveyed to the cutter 5 and the intermediate roller pair 4A along the second conveyance route L2. In a case where the cut sheet Ks is conveyed to the intermediate roller pair 4A, the controller 70 successively controls the intermediate motor 4AM, the conveyance motor 4BM, and the sheet discharge motor 4CM to thereby cause the cut sheet Ks to be conveyed toward the head 6.

In a case where the cut sheet Ks arrives at the position at which the cut sheet Ks is opposed to the head 6, the controller 70 controls the driver IC 6A to thereby cause the ink to be ejected from the nozzles onto the cut sheet Ks and to record the image. Then, the cut sheet Ks, on which the image has been recorded, is discharged to the sheet discharge tray 7. Thus, the control during the printing is ended for the cut sheet Ks.

### Notification Control of Printer 100

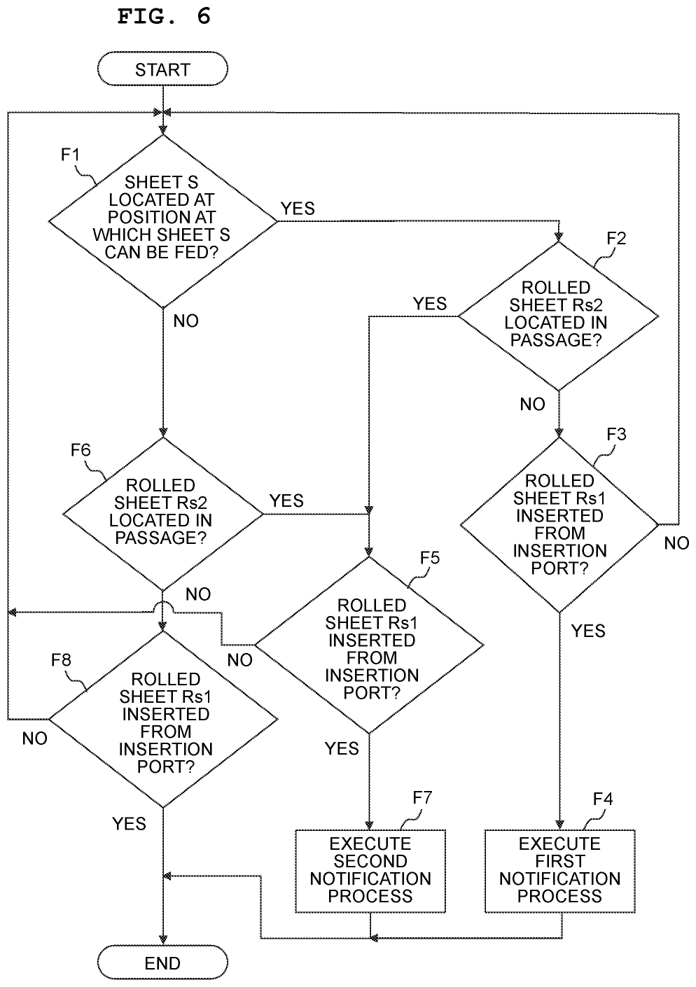

Next, notification control, which is to be performed in a case where the rolled sheet Rs1 is set to the printer 100, will be described. The controller 70 performs the process in accordance with a flowchart depicted in FIG. 6.

At first, the controller 70 determines whether the sheet S is located at the position at which the sheet S can be fed (step F1). In a case where the sixth signal is outputted from the sensor 93B and the sheet S is located at the position at which the sheet S can be fed (step F1: YES), the controller 70 determines whether the rolled sheet Rs2 is located in the passage 25 (step F2).

In a case where the third signal is outputted from the sensor 92B and the rolled sheet Rs2 is not located in the passage 25 (step F2: NO), the controller 70 determines whether the rolled sheet Rs1 is inserted from the insertion port 60 (step F3). In a case where the first signal is outputted from the sensor 91B and the rolled sheet Rs1 is not inserted from the insertion port 60 (step F3: NO), the controller 70 returns the procedure to step F1. On the other hand, in a case where the user inserts the rolled sheet Rs1 unwound from the first roll R1 from the insertion port 60 and the second signal is outputted from the sensor 92B (step F3: YES), the controller 70 executes a first notification process (F4).

The first notification process is a process which is executed in a case where the rolled sheet Rs1 is inserted in such a state that the cut sheet Ks is accommodated in the second accommodating part 30. In the first notification process, the controller 70 causes the notifying part 80 to notify the user of the removal of the cut sheet KS from the second accommodating part 30.

In step F2, in a case where the fourth signal is outputted from the sensor 92B and the rolled sheet Rs2 is located in the passage 25 (F2: YES), the controller 70 executes a process which is similar to the process executed in step F3.

Further, in step F1, in a case where the fifth signal is outputted from the sensor 93B and the sheet S is not located at the position at which the sheet S can be fed (step F1: NO), the controller 70 executes a process which is similar to the process executed in step F2 (step F6). In a case where the fourth signal is outputted from the sensor 92B, and the rolled sheet Rs2 is located in the passage 25 (F6: YES), the controller 70 proceeds to step F5.

In step F5, in a case where the first signal is outputted from the sensor 91B and the rolled sheet Rs1 is not inserted from the insertion port 60 (step F5: NO), the controller 70 returns the procedure to step F1. On the other hand, in a case where the user inserts the rolled sheet Rs1 unwound from the first roll R1 from the insertion port 60 and the second signal is outputted from the sensor 91B (step F5: YES), the controller 70 executes a second notification process (F7).

The second notification process is a process executed in a case where the rolled sheet Rs1 is inserted in a state in which the rolled sheet Rs2 of the second roll R2 accommodated in the first accommodating part 20 is located in the passage 25. In the second notification process, the controller 70 causes the notifying part 80 to notify the user that the second roll R2 needs to be removed from the first accommodating part 20 or the rolled sheet Rs2 needs to be removed from the passage 25, 27.

In step F6, in a case where the third signal is outputted from the sensor 93B and the rolled sheet Rs2 is not located in the passage 25 (step F6: NO), the controller executes a process which is similar to the process executed in step F3 (step F8). In a case where the first signal is outputted from the sensor 91B and the rolled sheet Rs1 is not inserted from the insertion port 60 (step F8: NO), the controller 70 returns the procedure to step F1. On the other hand, in a case where the user inserts the rolled sheet Rs1 unwound from the first roll R1 from the insertion port 60 and the second signal is outputted from the sensor 91B (step F8: YES), the rolled sheet Rs1 is inserted in a state in which the cut sheet Ks is not accommodated in the second accommodating part 30 and the rolled sheet Rs2 is not located in the passage 25, 27. Therefore, the controller 70 ends the procedure.

### Setting Operation for Rolled Sheet Rs1

In a case where the image is to be recorded on the rolled sheet Rs1, the rolled sheet Rs1 is set to the printer 100. At first, as depicted in FIG. 1, the user accommodates the first roll R1 in the accommodating part 210 of the accommodating unit 200. Then, the rolled sheet Rs1, which is unwound from the first roll R1, is drawn to the outside from the outlet 205 by the user, and the forward end of the rolled sheet Rs1 is inserted into the insertion port 60.

After that, the user feeds the rolled sheet Rs1 by an amount of a predetermined length along the first conveyance route L1. The phrase “amount of a predetermined length” referred to herein means a length which exceeds a length ranging from the insertion port 60 to the feed roller 2A along the first conveyance route L1, and is a length which is less than a length ranging from the insertion port 60 to the cutter 5. In this situation, in a case where the first notification process of F4 described above is executed, the user removes the cut sheet Ks from the second accommodating part 30, and the user feeds the rolled sheet Rs1 again by the amount of the predetermined length. Further, in this situation, in a case where the second notification process of F7 is executed, the user removes the second roll R2 from the first accommodating part 20 or the user removes the rolled sheet Rs2 from the passage 25, 27, and the user feeds the rolled sheet Rs1 again by the amount of the predetermined length.

In this manner, the setting of the rolled sheet Rs1 to the printer 100 is completed, in which the rolled sheet Rs1 is nipped and held by the feed roller 2A and the base pad, thereby presenting the state in which the rolled sheet Rs1 can be fed.

As described above, according to the printer 100 of this embodiment, the rolled sheet Rs1, which is connected to the first roll R1 cut by the cutter 5, is held between the insertion port 60 and the cutter 5 by the feed roller 2A and the pair of rollers 61, 62. Accordingly, there is no need for such an operation, which would be otherwise performed, of inserting the forward end of the rolled sheet Rs1 formed by the cutting into the insertion port 60 again after the cutting of the rolled sheet Rs1 so that the rolled sheet Rs1 can be conveyed by the conveyer 3. As a result, the deterioration of convenience can be reduced, in a case where a new image is recorded after cutting the rolled sheet Rs1 unwound from the first roll R1 disposed outside the printer 100.

Further, the rolled sheet Rs1, which is connected to the first roll R1 cut by the cutter 5, is held between the insertion port 60 and the cutter 5. Accordingly, the insertion of the forward end of the rolled sheet Rs1 into the insertion port 60 is unnecessary in a case where the printing is performed next time. In a case where such a configuration, wherein the forward end of the rolled sheet Rs1 is inserted into the insertion port 60 every time when the printing is performed and where the printing is performed on the rolled sheet Rs1 connected to the cut first roll R1 is adopted, any failure in the conveyance, for example, such that the forward end of the rolled sheet Rs1 is caught by the insertion port 60, might be more likely to occur. However, in this embodiment, the insertion of the forward end of the rolled sheet Rs1 into the insertion port 60 is unnecessary, which would be otherwise required, every time when the next printing is performed after cutting the rolled sheet Rs1. As a result, the rolled sheet Rs1 can be smoothly conveyed, and the occurrence of the conveyance failure can be reduced.

The insertion port 60 is formed in the front surface 10A1 of the feed tray 1. Accordingly, the insertion port 60 is positioned in the front surface 10A1 which is the front with respect to the user. Accordingly, the operation of inserting the rolled sheet Rs1 unwound from the first roll R1 into the insertion port 60 and the operation of moving the feed tray 1 can be easily performed. Further, the feed tray 1 has the insertion port 60 in this configuration, thus eliminating the necessity of defining the insertion port 60 in the casing 100A. In a case where the insertion port 60 is to be formed in the casing 100A, the insertion port 60 is required to be formed at any location which is different from the area, of the casing 100A, in which the feed tray 1 is disposed, and hence the design of the casing 100A is complicated. However, by including the insertion port 60 in the feed tray 1, the insertion port 60 can be formed relatively easily.

The feed roller 2A can feed the rolled sheet Rs2 of the second roll R2 accommodated in the first accommodating part 20 and the cut sheet(s) Ks accommodated in the second accommodating part 30. Further, the feed roller 2A can also convey and hold the rolled sheet Rs1 inserted from the insertion port 60. The feed roller 2A functions as the holding part, and hence any member different from the feed roller 2A as the holding part is not required.

In a case where the rolled sheet Rs1, which is inserted from the insertion port 60, is conveyed along the first conveyance route L1, the cutter 5 can cut the rolled sheet Rs1. Further, in a case where the rolled sheet Rs2, which is unwound from the second roll R2, is conveyed along the first conveyance route L1, the cutter 5 can cut the rolled sheet Rs2. In other words, the cutter 5 can selectively cut the rolled sheet Rs1 and the rolled sheet Rs2. Accordingly, the rolled sheet Rs1 of the first roll R1 and the rolled sheet Rs2 of the second roll R2 can be cut by one cutter 5.

In a case where the sensor 91B outputs the second signal in a state in which the sensor 93B outputs the sixth signal, and/or the sensor 92B outputs the fourth signal, the controller 70 executes the process of F4 or the process of F7. Accordingly, the duplicate feeding of the cut sheet(s) Ks accommodated in the second accommodating part 30 or the rolled sheet Rs2 of the second roll R2 accommodated in the first accommodating part 20 and the rolled sheet Rs1 of the first roll R1 can be previously avoided.

As a modification, in a case where the second detecting part 92 (sensor 92B) and the third detecting part 93 (sensor 93B) are not included and where the sensor 91B outputs the second signal, the controller 70 may execute the process of step F4 or the process of step F7. Also in this case, the effect, which is similar to the effect as described above, can be obtained.

As for the second roll R2 which can be accommodated in the feed tray 1, the maximum length of the rolled sheet Rs2 is shorter than the maximum length of the rolled sheet Rs1 of the first roll R1. Accordingly, usage only of the second roll R2 would be sufficient for the user who does not use a large amount of the rolled sheet, and thus the usage of the first roll R1 is not necessary for the user. In this manner, by including the feed tray 1 which can accommodate the second roll R2 in the printer 100, the request of the user as described above can be also responded as well.

The feed tray 1 has the second accommodating part 30. Accordingly, the image can be also recorded on a plurality of sheets of cut sheet Ks stacked, in addition to the rolled sheet Rs1 of the first roll R1.

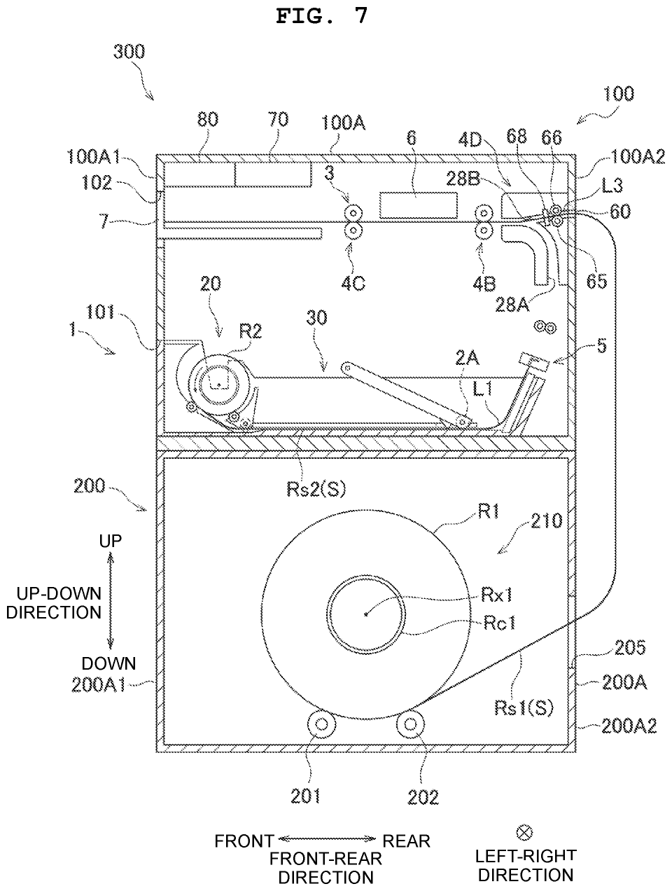

In the embodiment described above, the insertion port 60 is formed in the front surface 10A1 of the feed tray 1. However, as depicted in FIG. 7, an insertion port 60 may be formed in a rear surface 100A2 of a casing 100A of a printer 100. An accommodating unit 200 of a printer system 300 of this modification has an outlet 205 which is formed in a rear surface 200A2 of a casing 200A. The features other than the above are similar to the features of the accommodating unit 200 of the embodiment described above. The insertion port 60 is disposed at a position facing the guide 4D of the casing 100A in the front-rear direction.

As depicted in FIG. 7, the guide 4D of the printer 100 of this modification has a passage 28B defined therein, in addition to the passage 28A. The passage 28B is communicated with the insertion port 60. The passage 28B extends frontward from the insertion port 60, and the passage 28B merges with the passage 28A.

Further, the printer 100 includes a pair of conveyance rollers 65, 66 (“conveyer” of the present disclosure) and a cutter 68. As for the printer 100 of this modification, the features other than the above are similar to the features of the printer 100 described above.

The pair of conveyance rollers 65, 66 conveys the rolled sheet Rs1 inserted from the insertion port 60 along a third conveyance route L3. The third conveyance route L3 (“first conveyance route” of the present disclosure) is a route along which the rolled sheet Rs1 is conveyed from the insertion port 60 via the passage 28B to the cutter 68. Further, the pair of conveyance rollers 65, 66 are disposed between the insertion port 60 and the cutter 68 in the third conveyance route L3.

The cutter 68 is configured in the same manner as the cutter 5 of the embodiment described above. In this configuration, the rolled sheet Rs1 can be cut by driving the cutting motor (not depicted) by the controller 70.

One of the pair of conveyance rollers 65, 66 is a driving roller which is rotated by the transmission of the driving voltage of a conveyance motor (not shown), and the other is a driven roller which is rotated while following the driving roller. The driving roller is a roller which is equipped with a one-way clutch. Further, the pair of conveyance rollers (“holding part” of the present disclosure) 65, 66 also function as a holding part configured to nip and hold the rolled sheet Rs1 which is cut by the cutter 68 and which is connected to the first roll R1. Since the driving roller is the roller which is equipped with the one-way clutch, the rolled sheet Rs1 can be effectively held. Note that the one-way clutch of the driving roller may have a known torque limiter.

Note that the driving roller of the pair of conveyance rollers 65, 66 may be configured to be swingable by an arm in the same manner as the feed roller 2A. Also in such a configuration, the rolled sheet Rs1 can be effectively held in a similar manner as described above.

Further, the printer 100 has a switching mechanism (not depicted) which performs switching between a state in which the pair of conveyance rollers 65, 66 are brought in contact with each other and a state in which the pair of conveyance rollers 65, 66 are separated from each other. The user operates the switching mechanism to thereby realize the switching between a holding state in which the pair of conveyance rollers 65, 66 hold the rolled sheet Rs1 and a release state in which the rolled sheet Rs1 is released from the holding. Accordingly, the rolled sheet Rs1, which is held by the pair of conveyance rollers 65, 66, can be easily removed by switching the pair of conveyance rollers 65, 66 from the holding state to the release state.

In the printer 100 of this modification, as depicted in FIG. 7, in a case where an image is to be recorded on the rolled sheet Rs1, the rolled sheet Rs1, which is unwound from the first roll R1 accommodated in accommodating unit 200, is drawn to the outside from the outlet 205 by the user, and the forward end of the rolled sheet Rs1 is inserted into the insertion port 60. Then, the forward end of the rolled sheet Rs1 is caused to be nipped and held by the pair of conveyance rollers 65, 66. After that, in a case where the controller 70 receives the recording instruction to record the image on the rolled sheet Rs1, the controller 70 controls the pair of conveyance rollers 65, 66, the conveyance roller pair 4B, and the sheet discharge roller pair 4C to thereby cause the rolled sheet Rs1 to be conveyed toward the head 6 along the third conveyance route L3.

In a case where the rolled sheet Rs1 arrives at the position facing the head 6, the controller 70 controls the driver IC 6A to thereby record the image on the rolled sheet Rs1. Then, in a case where the cutting scheduled position, which is a part to be the rear end of the rolled sheet Rs1, arrives at the cutting position of the cutter 68, the controller 70 controls the pair of conveyance rollers 65, 66, the conveyance roller pair 4B, and the sheet discharge roller pair 4C so as to once stop the conveyance of the rolled sheet Rs1.

Subsequently, the controller 70 cuts the rolled sheet Rs1 by the cutter 68. The rolled sheet Rs1, which is connected to the cut first roll R1, is held by the pair of conveyance rollers 65, 66. In other words, such a state is maintained that the rolled sheet Rs1, which is connected to the cut first roll R1, is located in the casing 100A of the printer 100. Therefore, in a case where the controller 70 receives the recording instruction concerning the next printing, the conveyance of the rolled sheet Rs1 can be immediately started to execute the printing.

Subsequently, the controller 70 controls the conveyance roller pair 4B and the sheet discharge roller pair 4C so as to discharge the cut rolled sheet Rs, i.e., the rolled sheet Rs1 disposed downstream in the conveyance direction of the cutter 68 to the sheet discharge tray 7. In a case where the image is (to be) recorded on a part of the rolled sheet Rs1 disposed upstream in the conveyance direction of the head 6 after cutting the rolled sheet Rs1, the controller 70 controls the driver IC 6A so as to record the image on the rolled sheet Rs1. Thus, the control during the printing on the rolled sheet Rs1 is ended.

Note that in a case where an image is (to be) recorded on the rolled sheet Rs2, then the rolled sheet Rs2 is conveyed by the conveyer 3 along the first conveyance route L1 (“second conveyance route” of the present disclosure) in the same manner as the embodiment described above, and the image is recorded by the head 6. Further, a part (cutting scheduled position), which is to be the rear end of the rolled sheet Rs2, is cut by the cutter 5. The rolled sheet Rs2 cut and separated from the second roll R2 by the cutting, i.e., the rolled sheet Rs2 disposed downstream in the conveyance direction of the cutter 5 is discharged to the sheet discharge tray 7. Thus, the control during the printing on the rolled sheet Rs2 is ended.

Also in the case of the printer 100 of the modification as described above, the rolled sheet Rs1, which is connected to the first roll R1 cut by the cutter 68, is held between the insertion port 60 and the cutter 68 by the pair of conveyance rollers 65, 66. Therefore, such an operation that is to be performed in order that the rolled sheet Rs1 can be conveyed by the pair of conveyance rollers 65, 66 is unnecessary in the same manner as the embodiment described above. The deterioration of convenience can be reduced in a case where a new image is recorded.

The insertion port 60 is formed in the rear surface 100A2 of the casing 100A. Accordingly, even in a case where the feed tray 1 is moved in the front-rear direction with respect to the casing 100A, the tray 1 is prevented from interfering with the rolled sheet Rs1 of the first roll R1 inserted into the insertion port 60.

The printer 100 of this modification has the cutter 68 which cuts the rolled sheet Rs1 of the first roll R1 and the cutter 5 which cuts the rolled sheet Rs2 of the second roll R2. Accordingly, the cutter 68 and the cutter 5 need not to be made a common cutter in the printer 100. Accordingly, the use of the first roll R1 and the use of the second roll R2 can be switched smoothly.

In this modification, the printer 100 has the two cutters 5, 68. However, one cutter may be provided downstream in the conveyance direction of the location at which the passage 28A and the passage 28B merge. Accordingly, the rolled sheet Rs1 and the rolled sheet Rs2 can be selectively cut by one cutter.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The embodiment of the present disclosure has been described above. However, the present disclosure is not limited to the embodiment described above. Various changes can be made within a range defined in claims. In the embodiment described above, the insertion port 60 is formed in the front surface 10A1 of the feed tray 1. However, the insertion port 60 may be formed in the front surface 100A1 of the casing 100A. For example, the insertion port 60 may be formed at a part, of the casing 100A, which is disposed below the feed tray 1. Also in this case, the effect, which is similar to the effect of the embodiment described above, can be obtained.

Further, the feed roller 2A and the roller 61 may be any roller other than rollers equipped with one-way clutches, provided that the feed roller 2A and the roller 61 have the resistance to such an extent that the held rolled sheet Rs1 does not fall out from the insertion port 60. In this case, the pair of rollers 61, 62 may be configured so that the pair of rollers 61, 62 cannot be separated from each other, and/or the feed roller 2A may be configured so that the feed roller 2A cannot be retracted as well. Note that the pair of conveyance rollers 65, 66 may be also configured in the same manner as described above. Further, in a case where the feed roller 2A has the function of holding the rolled sheet Rs1, the pair of rollers 61, 62 may be omitted. Further, the base pad may be omitted.

Further, in a case where the pair of rollers 61, 62 function as the holding part, the feed roller 2A may not function as the holding part. In this case, the pair of rollers 61, 62 may be disposed at any position, provided that the position is disposed between the insertion port 60 and the cutter 5 in the first conveyance route L1.

Further, in a case where the configuration is adopted so that the rolled sheet Rs can be conveyed by the pair of rollers 61, 62, the feed roller 2A may be omitted.

Further, the feed tray 1 may be omitted in the printer 100. In this case, the insertion port 60 may be formed in the front surface 100A1 or the rear surface 100A2 of the casing 100A. Further, the feed tray 1 may include either one of the first accommodating part 20 and the second accommodating part 30.

Further, in a case where the insertion port 60 is formed in the front surface 100A1 of the casing 100A or the front surface 10A1 of the feed tray 1, the accommodating unit 200 may be disposed on the front side of the printer 100. Further, in a case where the insertion port 60 is formed in the rear surface 100A2 of the casing 100A, the accommodating unit 200 may be disposed on the rear side of the printer 100. Further, the rolled sheet Rs1 may be inserted into the insertion port 60 of the printer 100 so that the printing surface of the rolled sheet Rs1 unwound from the first roll R1 serves as an inner surface positioned on the inner side of the first roll R1.

The maximum length of the rolled sheet Rs2 of the second roll R2 may be equal to or greater than the maximum length of the rolled sheet Rs1 of the first roll R1. Further, the first detecting part 91 (sensor 91B) and the notifying part 80 may be omitted. Further, a sensor, which can directly detect the rolled sheet Rs1, may be adopted as the sensor 91B. By doing so, the actuator 91A may be omitted.

Further, in the embodiment and the modification described above, the cutter 5, 68 has the fixed blade 5A. However, the cutter 5 may include a rotary blade which is movable in the left-right direction together with the rotary blade 5B, instead of the fixed blade 5A. Note that the rotary blade may be any blade which is not rotatable.

The present disclosure is generally applicable to any image recording apparatus which can record an image on the rolled sheet Rs1 unwound from the first roll R1 disposed outside. Further, the first roll R1 may be not accommodated in the accommodating unit 200. Further, the support plate 31 may be omitted in the printer 100. The feed tray 1 may be supported movably in a direction crossing the front-rear direction and the up-down direction with respect to the casing 100A.

Further, for example, the present disclosure is also applicable not only to an ink-jet printer which includes, as the recording part, a head which ejects an ink from the nozzles, but also to any printer based on the laser system in which an electrostatic latent image is formed by exposing a photosensitive member with a laser and to any electrophotography printer which includes a recording part based on the LED system for forming an electrostatic latent image by exposing a photosensitive member with LED. Further, the sheet-shaped medium is not limited to a paper sheet. The sheet-shaped medium may be cloth or any resin material such as a film or the like provided that the sheet-shaped medium has a sheet-shaped form.

What is claimed is:

1. An image recording apparatus configured to record an image on a sheet, comprising:
an insertion port into which a sheet unwound from a first roll disposed outside the image recording apparatus is inserted;
a conveyer configured to convey the sheet inserted from the insertion port, along a first conveyance route in a conveyance direction; and
a cutter configured to cut the sheet conveyed by the conveyer, the cutter being located downstream in the conveyance direction of the insertion port in the first conveyance route, wherein
the conveyer includes a holding part configured to hold the sheet cut by the cutter, the holding part being located between the insertion port and the cutter in the first conveyance route.

2. The image recording apparatus according to claim 1, further comprising:
a casing; and
a feed tray having an accommodating part configured to accommodate the sheet and configured to move in a front-rear direction with respect to the casing, wherein
the insertion port is located on one of a front surface of the casing and a front surface of the feed tray.

3. The image recording apparatus according to claim 2, wherein
the insertion port is located on the front surface of the feed tray.

4. The image recording apparatus according to claim 2, wherein
the holding part includes a feed roller configured to feed the sheet accommodated in the accommodating part toward the cutter, and
the feed roller is configured to convey and hold the sheet inserted from the insertion port.

5. The image recording apparatus according to claim 1, further comprising:
a casing; and
a feed tray configured to accommodate a second roll around which a sheet is wound, wherein
the cutter is configured to selectively cut the sheet inserted from the insertion port and the sheet unwound from the second roll.

6. The image recording apparatus according to claim 1, further comprising:
a feed tray including an accommodating part configured to accommodate the sheet;
a sensor configured to detect the sheet inserted from the insertion port;
a notifying part; and
a controller, wherein
the conveyer is configured to convey the sheet accommodated in the accommodating part, and
the controller is configured to cause the notifying part to notify a user of removal of the sheet accommodated in the accommodating part from the accommodating part in accordance with detection of the sheet by the sensor.

7. The image recording apparatus according to claim 1, further comprising a feed tray configured to accommodate a second roll around which a sheet shorter than a maximum length of the sheet of the first roll is wound.

8. The image recording apparatus according to claim 1, further comprising a feed tray configured to accommodate a plurality of the sheets stacked.

9. The image recording apparatus according to claim 1, further comprising:
a casing; and
a feed tray configured to accommodate the sheet, the feed tray being configured to move in the front-rear direction with respect to the casing, wherein
the insertion port is formed in a rear surface of the casing.

10. The image recording apparatus according to claim 9, wherein
the feed tray is configured to accommodate a second roll around which a sheet is wound,
the conveyer is configured so that the sheet unwound from the second roll is conveyed along a second conveyance route, and
the image recording apparatus further comprises another cutter which is different from the cutter, the another cutter being disposed in the second conveyance route, and configured to cut the sheet unwound from the second roll.
